(19) United States
(12) Patent Application Publication
(10) Pub. No.: US 2011/0141007 A1
(43) Pub. Date: Jun. 16, 2011

(54) DATA PROCESSING APPARATUS, DATA PROCESSING SYSTEM, AND DISPLAY CONTROL METHOD FOR CONTROLLING DISPLAY IN DATA PROCESSING APPARATUS

(75) Inventor: Hiroshi Yamamizu, Yokohama-shi (JP)

(73) Assignee: CANON KABUSHIKI KAISHA, Tokyo (JP)

(21) Appl. No.: 12/959,322

(22) Filed: Dec. 2, 2010

(30) Foreign Application Priority Data
Dec. 10, 2009 (JP) 2009-280992

(51) Int. Cl. G09G 5/00

(52) U.S. Cl. 345/156

(57) ABSTRACT

A data processing apparatus includes a control apparatus configured to control the data processing apparatus and a display apparatus configured to display information, wherein the control apparatus includes a first display control unit configured to control display in the display apparatus and a transfer unit configured to transfer data to be displayed by the display apparatus to the display apparatus, wherein the display apparatus includes a second display control unit configured to control display in the display apparatus and a switching unit configured to switch between the first display control unit and the second display control unit, and wherein, after the switching unit switches from the first display control unit to the second display control unit, the second display control unit controls display in the display apparatus based on the data transferred by the transfer unit.

### BACKGROUND OF THE INVENTION

1. Field of the Invention

The present invention relates to a data processing apparatus, a data processing system, and a display control method for controlling display in the data processing apparatus.

2. Description of the Related Art

Japanese Patent Application Laid-open No. 05-127475 discusses a data processing apparatus which includes a plurality of liquid crystal display (LCD) controllers for controlling display in the LCD and in which the two LCD controllers are switched according to a selected condition.

Even when a data processing apparatus includes a plurality of display control units for controlling display in a display apparatus, if the data processing apparatus is shifted to a power saving mode or a power-off mode, power supply to each of the plurality of display control units is stopped and thus nothing is displayed on the display apparatus.

### SUMMARY OF THE INVENTION

According to an aspect of the present invention, a data processing apparatus includes a control apparatus configured to control the data processing apparatus and a display apparatus configured to display information, wherein the control apparatus includes a first display control unit configured to control display in the display apparatus and a transfer unit configured to transfer data to be displayed by the display apparatus to the display apparatus, wherein the display apparatus includes a second display control unit configured to control display in the display apparatus and a switching unit configured to switch between the first display control unit and the second display control unit, and wherein, after the switching unit switches from the first display control unit to the second display control unit, the second display control unit controls display in the display apparatus based on the data transferred by the transfer unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a data processing system according to an exemplary embodiment of the invention.

FIG. 2 is a block diagram illustrating a hardware configuration of a control apparatus.

FIG. 3 is a block diagram illustrating a hardware configuration of an operation apparatus of the data processing apparatus.

FIG. 4 is a flow chart illustrating switching processing for switching between an LCD controller of the control apparatus and an LCD controller of the operation apparatus.

FIG. 5 illustrates an example of a screen that is displayed on the LCD when processing is switched to control of the LCD by the LCD controller of the operation apparatus.

FIG. 6 illustrates an example of a screen that is displayed on the LCD when the apparatus is returned from a sleep mode.

FIG. 7 illustrates an example of a screen that is displayed on the LCD.

FIG. 8 is a flow chart illustrating switching processing for switching between the LCD controller of the control apparatus and the LCD controller of the operation apparatus when an error occurs in the control apparatus.

FIG. 9 illustrates an example of a screen displayed on the LCD.

### DESCRIPTION OF THE EMBODIMENTS

Various exemplary embodiments, features, and aspects of the invention will be described in detail below with reference to the drawings.

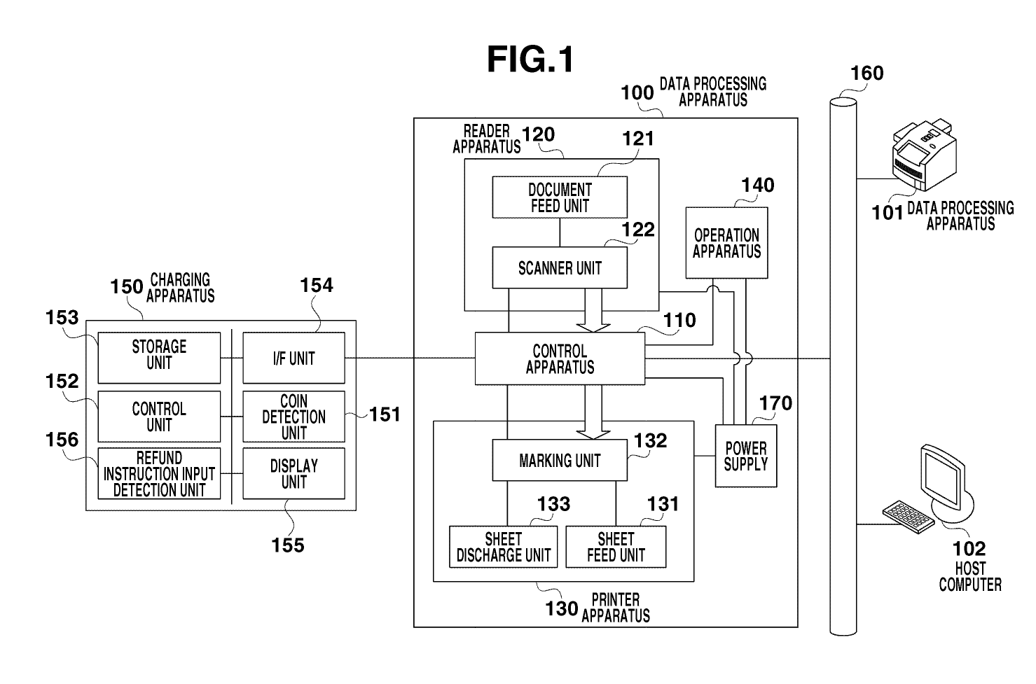

FIG. 1 is a block diagram illustrating a configuration of a data processing system according to an exemplary embodiment of the present invention. A data processing apparatus 100 includes various image processing functions such as printing, image inputting, document filing, document transmission, and image conversion.

A reader apparatus 120 optically reads a document image to convert the document image into image data. The reader apparatus 120 includes a document feed unit 121 having a function for conveying documents and a scanner unit 122 having a function for reading the documents.

More detailed description is included below regarding a configuration and an operation of the reader apparatus 120. A scanner unit 122 includes a plurality of charge-coupled devices (CCDs). In a case where sensitivities of the CCDs differ from each other, even if densities of pixels on the document are the same to each other, the apparatus may regard the read pixels as having different densities. In order to correct the above, the scanner unit 122 initially exposes a white board (a board uniformly white in its entirety) to light the white board for scanning. Then, the scanner unit 122 converts an amount of reflected light obtained by the exposure and the scan into an electric signal and outputs the electric signal to a control apparatus 110.

An operation of the reader apparatus 120 when the reader apparatus 120 scans over an image on a document is described below. The scanner unit 122 inputs reflected light obtained by exposing and scanning the image on the document through the CCD, and thereby converts the image into an electric signal. The scanner unit 122 further converts the electric signal into a luminance signal including colors of red (R), green (G), and blue (B) and outputs the luminance signal as image data to the control apparatus 110.

The document is sent to a tray of the document feed unit 121. When a user operates an operation apparatus 140 to instruct the start of a reading operation, the control apparatus 110 gives a reading instruction to the scanner unit 122. When the scanner unit 122 receives the reading instruction, the scanner unit 122 causes documents to be fed one by one from the tray of the document feed unit 121 to read the document image. A reading method for the document image may be a method in which a document is positioned on a glass plate and an exposure unit is moved to scan the document in addition to a method in which the document feed unit 121 automatically conveys a document to subject the document to scanning processing while the exposure unit is fixed.

A printer apparatus 130 conveys recording paper, prints image data on the recording paper in the form of a visual image, and discharges the recording paper with the image printed thereon to the outside of the data processing apparatus. The printer apparatus 130 includes a sheet feed unit 131 having a plurality of recording paper cassettes capable of storing a plurality types of recording paper and a marking unit 132 having a function for transferring an image onto the recording paper based on the image data and fixing the image on the recording paper. Further, the printer apparatus 130 includes a sheet discharge unit 133 having a function for sorting or stapling the recording paper on which an image is printed and outputting the recording paper to the outside of the apparatus.

The printer apparatus 130 forms an image on paper based on image data received from the control apparatus 110. Examples of the image forming method include an electrophotographic method that uses a photosensitive drum and a photosensitive belt and an ink-jet method in which inks are discharged from arrays of micronozzles to print an image on paper.

The operation apparatus 140 may include a liquid crystal-type touch panel and provide a user interface for operating the data processing apparatus 100.

The data processing apparatus may include or be associated with means for obtaining payment for its functions. A charging apparatus 150 thus performs charging processing. A coin detection unit 151 detects a coin inserted by the user.

A control unit 152 calculates the sum of the inserted coins and an adjusted amount charged in using a function according to a program stored in a storage unit 153. Data of this calculation result is transmitted from the control unit 152 to the data processing unit 100 via an interface unit 154. A display unit 155 displays the sum of the inserted coins, the adjusted amount charged in using the function, and a remaining deposit amount after adjustment. A refund instruction input detection unit 156 detects a refund instruction of the inserted coins input by the user. In addition to the above, the charging apparatus 150 includes a coin return slot for refunding the remaining deposit to the user and a refund button for allowing the user to input the refund instruction (not illustrated).

A local area network (LAN) 160 connects the data processing apparatus 100, a data processing apparatus 101, and a host computer 102 to each other. Thus, the data processing apparatus 100, the data processing apparatus 101, and the host computer 102 can communicate with each other via the LAN 160.

The control apparatus 110 is electrically connected to each of the reader apparatus 120, the printer apparatus 130, the operation apparatus 140, the charging apparatus 150, and the LAN 160. To provide a copying function, the control apparatus 110 controls the reader apparatus 120 to generate image data of a document and controls the printer apparatus 130 to print an image on recording paper based on the image data.

To provide a scanner function, the control apparatus 110 converts image data generated by the reader apparatus 120 into code data and transmits the code data to the host computer 102 via the LAN 160. To provide a printer function, the control apparatus 110 receives code data from the host computer 102 via the LAN 160, converts the code data into image data, and controls the printer apparatus 130 to print an image on recording paper based on the image data.

In the charging processing, the control apparatus 110 receives data of the calculation result, e.g., the sum of the inserted coins and the adjusted amount, from the interface unit 154 of the charging apparatus 150. The control apparatus 110 determines, based on the thus received data of the calculation result, whether the designated copying processing is available by the operation apparatus 140, i.e., whether the sum of the inserted coins is sufficient (in a “charge check”) . On the other hand, after the execution of the copying processing, the control apparatus 110 determines the presence or absence of the remaining deposit (in a “remaining deposit check”) . The control apparatus 110 receives the data of the calculation result from the charging apparatus 150, so that the control apparatus 110 can perform the remaining deposit check by itself based on a program, stored in the ROM, for controlling the copying processing. Since the remaining deposit amount is displayed on the display unit 155 of the charging apparatus 150, the control apparatus 110 transmits data indicative of the remaining deposit amount to the charging apparatus 150.

The charging apparatus 150 may be configured such that not only coins but also bills can be inserted therein. The control apparatus 110 also may be configured such that the charge check and the remaining deposit check can be performed with respect to the scanner function and the printer function in addition to the charge check and the remaining deposit check with respect to the copying function.

A power source 170 supplies electric power to the reader apparatus 120, the printer apparatus 130, the operation apparatus 140, and the control apparatus 110.

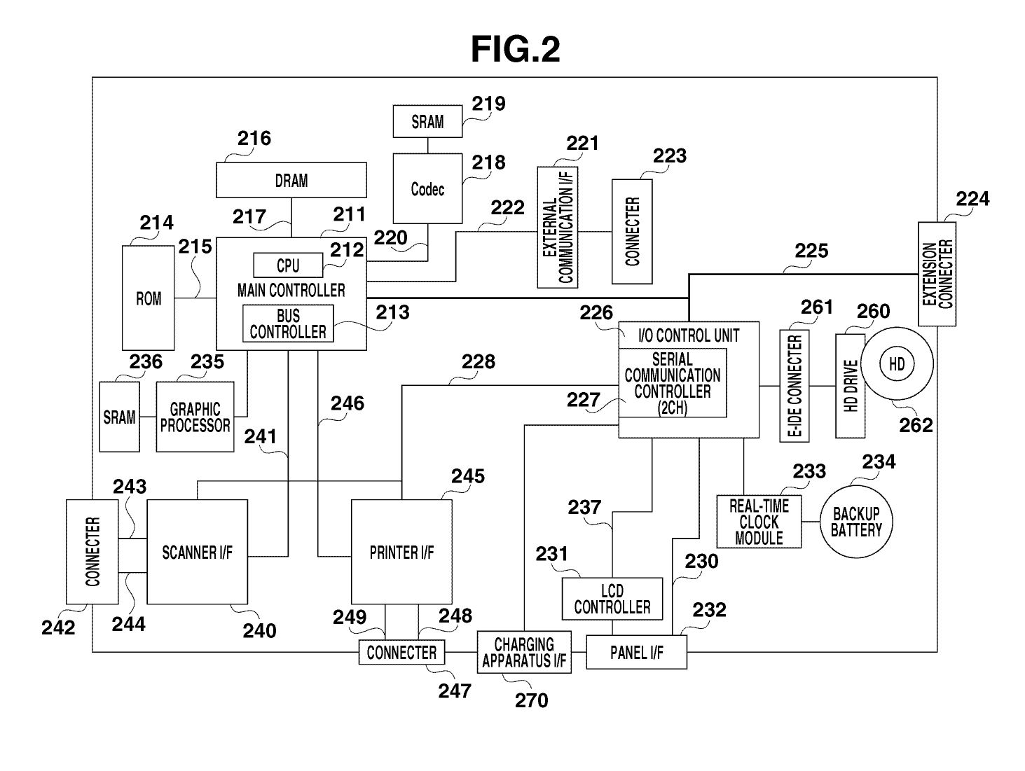

FIG. 2 is a block diagram illustrating a hardware configuration of the control apparatus 110.

A main controller 211 includes a central processing unit (CPU) 212, a bus controller 213, and various types of interface (I/F) controller circuits. The CPU 212 and the bus controller 213 are configured to control operations of the control apparatus 110. The CPU 212 operates according to a program read from a ROM 214 via a ROM I/F 215. For example, an operation to interpret page-description language (PDL) code data received from the host computer 102 to rasterize it into raster image data is described in the program, and the conversion of the PDL data into the raster image data is processed by software. The bus controller 213 is configured to control data transfer via each I/F and also control arbitration upon bus competition and direct memory access (DMA) data transfer.

A dynamic random access memory (DRAM) 216 is connected to the main controller 211 via a DRAM I/F 217. The DRAM 216 is provided with a work area to be used when the CPU 212 is operated and a storage area for storing image data.

A codec 218 is connected to the main controller 211 via a codec I/F 220. The codec 218 compresses raster image data stored in the DRAM 216 according to Modified Huffman (MH) method, Modified READ (MR) method, Modified Modified READ (MMR) method, Joint Bi-level Image Experts Group (JBIG) method, or Joint Photographic Experts Group (JPEG) method and decompresses the compressed data to be stored in the DRAM 216 into raster image data. A static random access memory (SRAM) 219 is temporally used as a work area by the codec 218. Data transfer performed between the main controller 211 and the codec 218 via the codec I/F 220 is controlled by the bus controller 213 to perform DMA transfer.

A graphic processor 235 performs image rotating processing, scaling processing, and color space conversion processing. A SRAM 236 is temporally used as a work area by the graphic processor 235.

An external communication I/F 221 is connected to the main controller 211 via an I/F 222 and connected to an external network via a connecter 223.

A general high-speed bus 225 is connected to an expansion connecter 224 for connecting an expansion board and an input/output (I/O) control unit 226 in addition to the main controller 211. An example of the general high-speed bus includes a Peripheral Component Interconnect (PCI) bus.

The I/O control unit 226 is provided with two channels of asynchronous serial communication controller 227 for transmitting a control command between the CPU of the reader apparatus 120 and the CPU of the printer apparatus 130. The I/O control unit 226 is connected to a scanner I/F 240 and a printer I/F 245 via an I/O bus 228.

A panel I/F 232 is connected to the I/O control unit 226 via an LCD controller 231 and a display I/F 237. The panel I/F 232 is also connected to the I/O control unit 226 via a key input I/F 230. The operation apparatus 140 includes a liquid crystal display (LCD) , a touch panel attached to the LCD, and a plurality of hard keys . A signal input through the touch panel and the hard keys is transmitted to the CPU 212 via the panel I/F 232, the key input I/F 230, the I/O control unit 226. Screen data to be displayed on the LCD is transmitted to the LCD via the I/O control unit 226, the LCD controller 231, and the panel I/F 232. The LCD displays, based on the screen data, a screen indicating a function or a state of the data processing apparatus, an operation screen for operating the data processing apparatus, and a preview screen for showing image data to the user.

A real-time clock module 233 is configured to update and store a date and time to be managed by the data processing apparatus 100. The real-time clock module 233 operates by using battery power supplied by a backup battery 234.

An E-IDE (Enhanced Integrated Device Electronics) connecter 261 is configured to connect an external storage device. In FIG. 2, a hard disk 262 is connected as the external storage device. The I/O control unit 226 is connected to a hard disk drive 260 via the E-IDE connecter 261, the hard disk drive 260 causing the hard disk 262 to store image data and reading the image data from the hard disk 262.

A connecter 242 is connected to the reader apparatus 120 and includes an asynchronous serial I/F 243 and a video I/F 244. A connector 247 is connected to the printer apparatus 130 and includes an asynchronous serial I/F 248 and a video I/F 249.

The scanner I/F 240 is connected to the reader apparatus 120 via the connecter 242 and connected to the main controller 211 via a scanner bus 241. The scanner I/F 240 has functions to provide predetermined processing to the image data received from the reader apparatus 120, to generate a control signal based on a video control signal received from the reader apparatus 120, and to output the control signal to the scanner bus 241. Data transfer from the scanner bus 241 to the DRAM 216 is controlled by the bus controller 213.

The printer I/F 245 is connected to the printer apparatus 130 via the connecter 247 and to the main controller 211 via the printer bus 246. The printer I/F 245 has functions to provide predetermined processing to the image data received from the main controller 211, to generate a control signal based on a video control signal received from the printer apparatus 130, and to output the control signal to the printer bus 246. The bus controller 213 controls the transfer of raster image data rasterized in the DRAM 216 to the printer apparatus 130 and it DMA-transfers the raster image data to the printer apparatus 130 via the printer bus 246 and the video I/F 249.

A charging apparatus I/F 270 is connected to the charging apparatus 150 and receives data of a calculation result such as the sum of inserted coins and the adjusted amount.

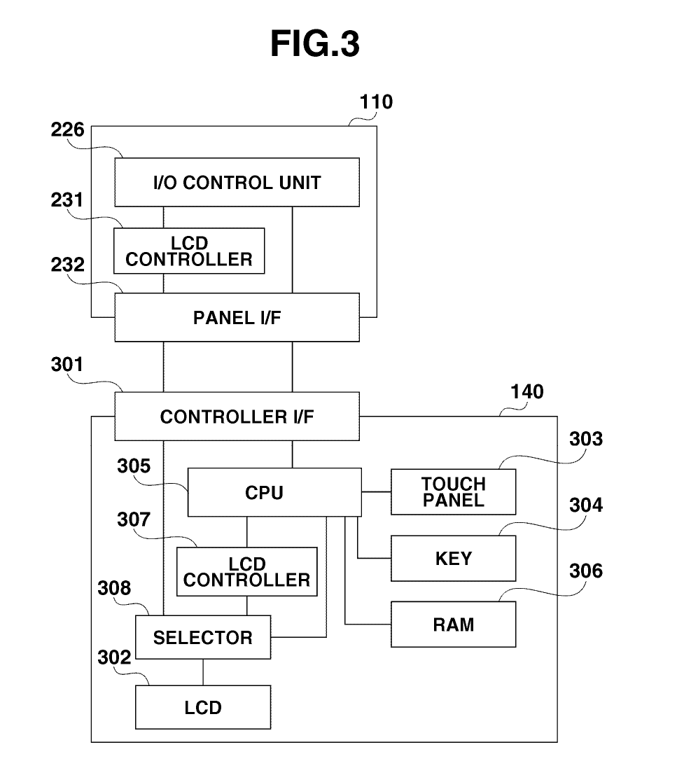

FIG. 3 is a block diagram illustrating a hardware configuration of the operation apparatus 140 of the data processing apparatus 100. A controller I/F 301 is connected to the panel I/F 232 of the control apparatus 110. The controller I/F 301 receives screen data to be displayed on an LCD 302 from the LCD controller 231 via the panel I/F 232. The controller I/F 301 transmits a signal input through a touch panel 303 or a hard key 304 to the I/O control unit 226 via the panel I/F 232.

The LCD controller 231 transmits a control signal and screen data to be displayed to the LCD 302 and controls the display of the LCD 302.

A CPU 305 transmits a signal input through the touch panel 303 or the hard key 304 to the I/O control unit 226. The CPU 305 receives screen data to be displayed on the LCD 302 from the I/O control unit 226 to store the screen data in a RAM 306. Further, the CPU 305 has a function to control a selector 308 for switching between control of the LCD 302 by the LCD controller 231 and control of the LCD 302 by the LCD controller 307.

The LCD controller 307 (a second LCD controller) also transmits the control signal or the screen data to be displayed to the LCD 302 and also controls the display of the LCD 302. In a case where the screen data is transmitted from the control apparatus 110 to be stored in the RAM 306, the LCD controller 307 reads out the screen data from the RAM 306 and controls the LCD 302 so as to display a screen based on the screen data.

The control apparatus 110 and the operation apparatus 140 have respective independent power source systems. Each of the power source systems can perform control independently, i.e., can cause only the control apparatus 110 to be in a power saving mode (hereinafter referred to as the “sleep mode”) while the operation apparatus 140 is left as it is (in a normal mode). In the sleep mode, each of the power source systems can reduce power supply to, for example, the CPU 212 or the LCD controller 231 or stop power supply to the CPU 212 or the LCD controller 231.

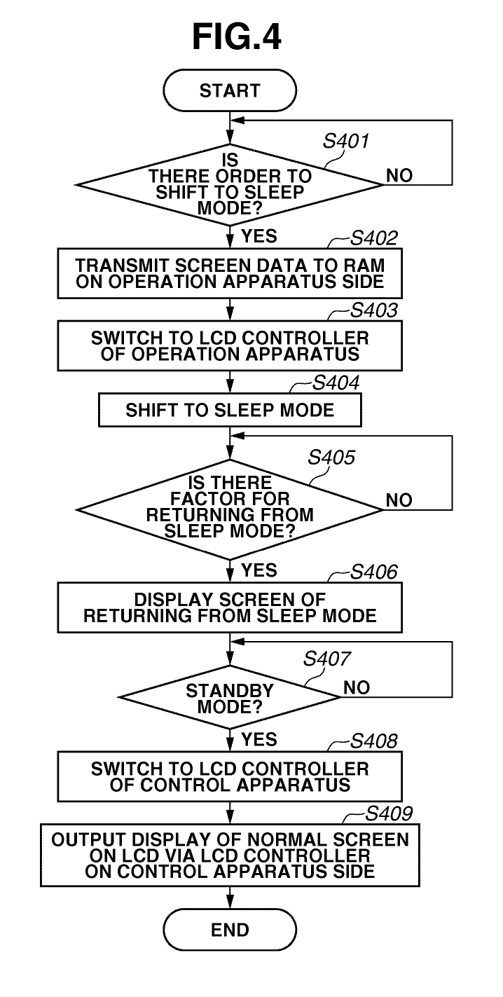

FIG. 4 is a flow chart illustrating switching processing for switching between the LCD controller 231 of the control apparatus 110 and the LCD controller 307 of the operation apparatus 140.

In step S401, the I/O control unit 226 determines the presence or absence of a shifting-to-sleep instruction input by the user by operating the operation apparatus 140. In a case where the I/O control unit 226 determines that the shifting-to-sleep instruction is issued in step S401 (YES in step S401), the processing proceeds to S402. In a case where the apparatus is to be shifted to the sleep mode according to the absence of an operation of the user for a predetermined time period or the absence of entry of a job for a predetermined time period, the I/O control unit 226 determines the presence or absence of a notification from the CPU 212 to the extent that the apparatus is shifted to the sleep mode.

In step S402, the I/O control unit 226 transmits screen data to be displayed on the LCD 302 while the apparatus is in the sleep mode or screen data to be displayed on the LCD 302 when the apparatus is returned from the sleep mode to the operation apparatus 140, and the CPU 305 causes the RAM 306 to store the screen data. The screen data to be transferred at that time is the one stored in any one of the ROM 214, the DRAM 216, or the hard disk 262 of the control apparatus 110.

In step 403, the CPU 305 controls the selector 308 to switch the control of the LCD 302 by the LCD controller 231 to the control of the LCD 302 by the LCD controller 307 according to the instruction from the I/O control unit 226. Accordingly, the LCD controller 307 controls screen display of the LCD 302. At that time, the LCD controller 307 reads the screen data stored in the RAM 406 in step S402 from the RAM 306 and controls the LCD 302 to display a screen based on the screen data.

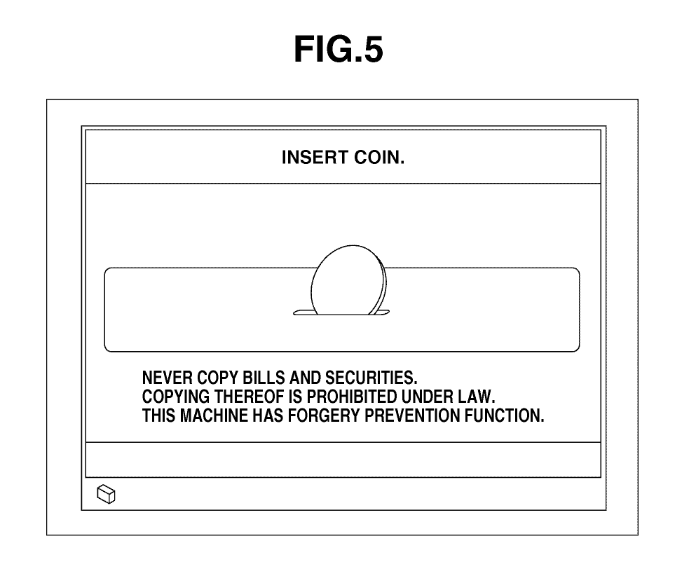

FIG. 5 illustrates an example of a screen to be displayed on the LCD 302 while the apparatus is in the sleep mode. This screen is made on the assumption that, but not limited to a case where, the screen is displayed by a self-service type copying machine such as the one placed in a convenience store.

In step S404, the CPU 212 causes the control apparatus 110 to shift to the sleep mode.

In step S405, the CPU 305 of the operation apparatus 140 and the I/O control unit 226 of the control apparatus 110 each determine the presence or absence of a factor for returning from the sleep mode. Examples of the factor for returning from the sleep mode include a case where the coin detection unit 151 of the charging apparatus 150 detects an insertion of coins and a case where the user operates the operation apparatus 140. In a case where there is the factor for returning from the sleep mode (YES in step S405), the processing proceeds to step S406.

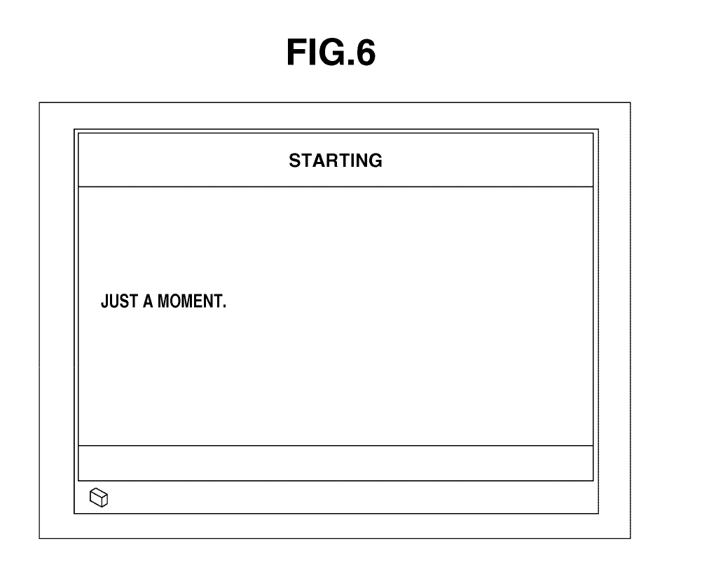

In step S406, the LCD controller 307 reads the screen data stored in the RAM 306 in step S402 and controls the LCD 302 to display a screen based on the screen data. FIG. 6 illustrates an example of a screen to be displayed on the LCD 302 when the apparatus is returned from the sleep mode.

In step S407, the CPU 305 determines whether the control apparatus 110 has returned from the sleep mode and is in a standby mode based on the notification from the I/O control unit 226. In a case where the CPU 305 determines that the apparatus is in the standby mode (YES in step S407), the processing proceeds to step S408. In step S408, the CPU 305 controls the selector 308 to switch from the control of the LCD 302 by the LCD controller 307 to the control of the LCD 302 by the LCD controller 231.

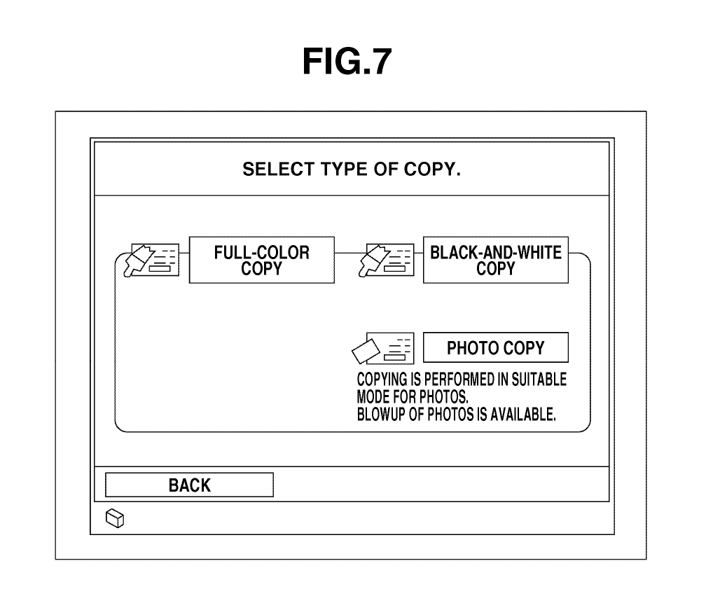

In step S409, the LCD controller 231 of the control apparatus 110 controls screen display by the LCD 302. FIG. 7 illustrates an example of a screen to be displayed on the LCD 302 at that time; i.e. when the apparatus is in a normal mode.

The above-described switching processing enables saving of standby power of the control apparatus 110 while causing the LCD 302 to display necessary information (e.g., a screen illustrated in FIG. 5).

The control apparatus 110 can concentrate on returning from the sleep mode independently from the display control if the screen data to be displayed when the apparatus returns from the sleep mode is displayed on the LCD 302 by using the LCD controller 307.

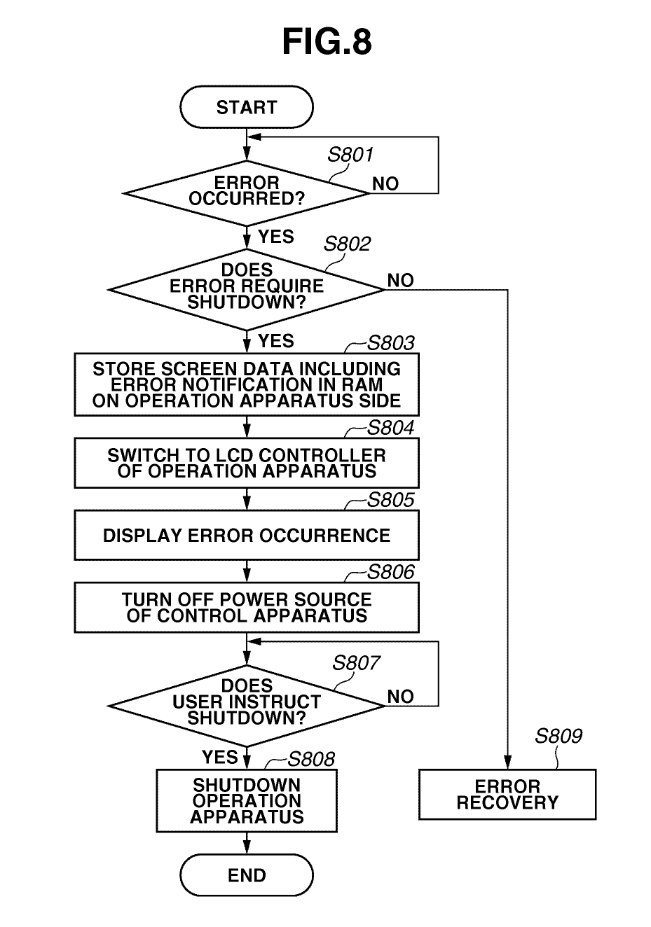

FIG. 8 is a flow chart illustrating switching processing for switching between the LCD controller 231 of the control apparatus 110 and the LCD controller 307 of the operation apparatus 140 in a case where an error occurs in the control apparatus 110.

In step S801, the CPU 212 of the control apparatus 110 determines the presence or absence of an occurrence of an error. In a case where the CPU 212 of the control apparatus 110 determines there is the error occurrence (YES in step S801), the processing proceeds to step S802. In step S802, the CPU 212 determines whether the occurred error is the one which requires shutdown. Examples of the error which requires the shutdown include a fan lock and an abnormality of an HDD. For example, if a fan does not rotate due to the fan lock, heating of the CPU 212 or the like cannot be controlled. If the power supply is continued under such condition, the CPU 212 also may crash. Accordingly, the apparatus needs to be shutdown to stop power supply. On the other hand, an example of the error which does not require the shutdown includes a paper jam.

In a case where the CPU 212 of the control apparatus 110 determines an error which does not require the shutdown (NO in step S802), the processing proceeds to step S809. In step S809, error cancelling processing, i.e., processing to announce the user to remove a jammed sheet of paper, is performed.

In a case where the CPU 212 of the control apparatus 110 determines that the error requires the shutdown (YES in step S802), the processing proceeds to S803. In step S803, the I/O control unit 226 transfers screen data for displaying a screen for notifying a content of the error detected in step S801 to the operation apparatus 140, and the CPU 305 stores the screen data in the RAM 306.

In step S804, the CPU 305 controls the selector 308 to switch from the control of the LCD 302 by the LCD controller 231 to the control of the LCD 302 by the LCD controller 307. In step S805, the LCD controller 307 reads out screen data stored in the RAM 306 in step S803 from the RAM 306 and controls the LCD 302 to display a screen based on the screen data.

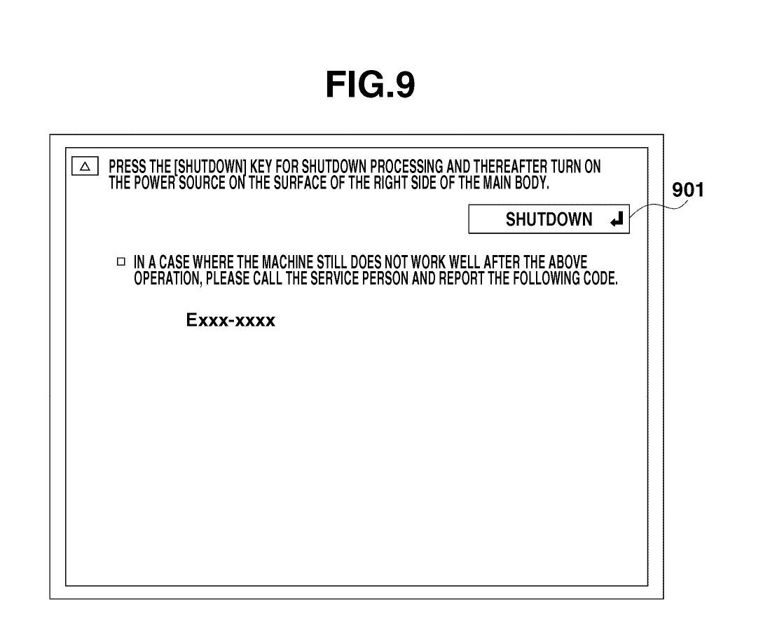

FIG. 9 is an example of the screen displayed on the LCD 302. In addition to a message illustrated in FIG. 9, a message indicating a reason why the control apparatus 110 causes the apparatus shutdown may be displayed.

In step S806, the CPU 212 of the control apparatus 110 turns off the power source of the control apparatus 110. In step S807, the CPU 305 of the operation apparatus 140 determines whether the user issues an instruction of shutdown. The instruction of shutdown is performed by pressing the touch panel 303 (i.e., pressing of a shutdown key 901 illustrated in FIG. 9), turning off of the power source switch, or the like. In step S808, the CPU 305 of the operation apparatus 140 turns off the power source of the operation apparatus 140.

The above-described switching processing enables turning off of the power source of the control apparatus 110 while necessary information (e.g., a screen illustrated in FIG. 9) is displayed on the LCD 302.

As described above, since the power source of the control apparatus 110 is turned off first, an extra power consumption while the apparatus cannot be used due to an error can be reduced. In a case where an error which may invite more serious crash due to heating of the control apparatus 110, such as a fan lock error, occurs, the above-described processing is also effective to prevention of the crash of the control apparatus 110.

Ina case where the display on the LCD 302 is simplified while the apparatus is in the sleep mode or the power source of the apparatus is turned off, the LCD controller 307 may be configured to have a simple configuration compared with the LCD controller 231. For example, the second LCD controller 307 may be configured to have no portion of function of the first LCD controller 231 or have a performance lower than that of the first LCD controller 231. In other words, the LCD controller first 231 normally controls in detail the display by the LCD 302, whereas the second LCD controller 307 controls the display of the LCD 302 effectively as a backup to the LCD controller 231 while the control apparatus 110 is in the sleep mode or in the power source off state.

In the block diagram of FIG. 1, the data processing apparatus 100 includes the operation apparatus 140; however, the operation apparatus 140 may be arranged outside the data processing apparatus 100 or may be detachable from the data processing apparatus 100. In this case, in a data processing system that includes the separate data processing apparatus 100 and operation apparatus 140, the switching processing illustrated in FIG. 4 or 8 is performed.

According to the above-described exemplary embodiments, the data processing apparatus can be shifted to the power saving mode or the power-off mode while the necessary information is displayed by the display apparatus.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-280992 filed Dec. 10, 2009, which is hereby incorporated by reference herein in its entirety.

What is claimed is:

1. A data processing apparatus comprising:
a control apparatus configured to control the data processing apparatus; and
a display apparatus configured to display information,
wherein the control apparatus comprises:
a first display control unit configured to control display in the display apparatus; and
a transfer unit configured to transfer data to be displayed by the display apparatus to the display apparatus,
wherein the display apparatus comprises:
a second display control unit configured to control display in the display apparatus; and
a switching unit configured to switch between the first display control unit and the second display control unit, and wherein, after the switching unit switches from the first display control unit to the second display control unit, the second display control unit controls display in the display apparatus based on the data transferred by the transfer unit.

2. The data processing apparatus according to claim 1, wherein the display apparatus includes a storage unit configured to store the data transferred by the transfer unit, and
wherein the second display control unit controls display in the display apparatus based on the data stored in the storage unit.

3. The data processing apparatus according to claim 1, wherein the switching unit switches from the first display control unit to the second display control unit when the control apparatus is shifted to a power saving mode.

4. The data processing apparatus according to claim 3, wherein the switching unit switches from the second display control unit to the first display control unit when the control apparatus returns from the power saving mode.

5. The data processing apparatus according to claim 3, wherein the data to be transferred by the transfer unit is data indicating a screen to be displayed while the control apparatus is shifted to the power saving mode.

6. The data processing apparatus according to claim 3, wherein, in the power saving mode, electric power is supplied to the second display control unit and no electric power is supplied to the first display control unit.

7. The data processing apparatus according to claim 1, the switching unit switches from the first display control unit to the second display control unit when a power source of the control apparatus is turned off.

8. A data processing apparatus comprising:
a control apparatus configured to control the data processing apparatus; and
a display apparatus configured to display information,
wherein the control apparatus comprises:
a first display control unit configured to control display in the display apparatus, and
wherein the display apparatus comprises:
a second display control unit configured to control display in the display apparatus; and
a switching unit configured to switch between the first display control unit and the second display control unit.

9. A data processing system including a data processing apparatus and a display apparatus configured to display information,
wherein the data processing apparatus comprises:
a first display control unit configured to control display in the display apparatus, and
wherein the display apparatus comprises:
a second display control unit configured to control display in the display apparatus; and
a switching unit configured to switch between the first display control unit and the second display control unit.

10. A display control method for controlling display in a data processing apparatus, the display control method comprising:
transferring, from a control apparatus configured to control the data processing apparatus to a display apparatus configured to display information, data to be displayed by the display apparatus;
switching from a first display control unit of the data processing apparatus configured to control display in the display apparatus to a second display control unit of the display apparatus configured to control display in the display apparatus; and
causing, after switching from the first display control unit to the second display control unit, the second display control unit to control display in the display apparatus based on the transferred data.

11. The data processing apparatus according to claim 1, wherein the information relates to an operation of the data processing apparatus.

12. The data processing apparatus according to claim 8, wherein the information relates to an operation of the data processing apparatus.

13. The data processing system according to claim 9, wherein the information relates to an operation of the data processing apparatus.

14. The display control method according to claim 10, wherein the information relates to an operation of the data processing apparatus.

15. A data processing apparatus comprising:
a display unit configured to display information;
first display control unit configured to control a display by the display apparatus;
second display control unit configured to control a display by the display apparatus; and
switching unit configured to switch between the first display control means and the second display control means.
